(19) United States
(12) Patent Application Publication
(10) Pub. No.: US 2013/0162519 A1
(43) Pub. Date: Jun. 27, 2013

(54) CROSS-PLATFORM HUMAN INPUT CUSTOMIZATION

(71) Applicants: Michael Ameling, Dresden (DE); Philipp Herzig, Oybin (DE); Ralf Ackermann, Dresden (DE)

(72) Inventors: Michael Ameling, Dresden (DE); Philipp Herzig, Oybin (DE); Ralf Ackermann, Dresden (DE)

(73) Assignee: SAP AG, Walldorf (DE)

(21) Appl. No.: 13/336,904

(22) Filed: Dec. 23, 2011

(51) Int. Cl. G09G 5/00

(52) U.S. Cl. 345/156

(57) ABSTRACT

An input handler may receive first human input events from at least one human input device and from at least one user, associate the first human input events with a first identifier, receive second human input events from the at least one human input device from the at least one user, and associate the second human input events with a second identifier. A command instructor may relate the first human input events and the second human input events to commands of at least one application, and instruct the at least one application to execute the commands including correlating each executed command with the first identifier or the second identifier

### TECHNICAL FIELD

This description relates to human input devices.

### BACKGROUND

Many different input devices and associated techniques have been developed for the purpose of enabling users to interact with computer applications and related hardware/software. For example, the mouse, the keyboard, the stylus, and many other such devices and related techniques have been long-used and are widely known to provide users with an ability to, e.g., input data, manipulate functionalities of software applications, and otherwise interact with such software applications and related computing platforms.

In related examples, touch screens have been developed which enable users to interact with software applications and related computing platforms in easy, intuitive manners, using finger-based interactions between the user and the related input device. For example, such touch screens may enable combinations or variations of finger motions, which are commonly referred to as gestures, and which are designed to result in specific, corresponding actions on the part of a corresponding application/operating system/platform. For example, such gestures may include a “pinching” motion using two fingers, to zoom out in a display setting, or, conversely, a “spreading” motion of expanding two fingers apart from one another to zoom in in such display settings. Further, devices exist which enable users to interact with software without requiring a touchscreen, and while still including gesture-based interactions. For example, some devices include accelerometers, gyroscopes, and/or other motion-sensing or motion-related technologies to detect user motions in a three-dimensional space, and to translate such motions into software commands. Somewhat similarly, techniques exist for detecting user body movements, and for translating such body movements into software commands.

As referenced above, such input devices and related techniques may be well-suited to provide their intended functions in the specific context(s) in which they were created, and in which they have been developed and implemented. However, outside of these specific contexts, such input devices and related techniques may be highly limited in their ability to provide a desired function and/or obtain an intended result.

For example, many such input devices and related techniques developed at a particular time and/or for a particular computing platform may be unsuitable for use in a different context than the context in which they were developed. Moreover, many such input devices and related techniques may be highly proprietary, and/or may otherwise be difficult to configure or customize across multiple applications. Still further, such input devices and related techniques, for the above and related reasons, may be difficult or impossible to use in a collaborative fashion (e.g., between two or more collaborating users).

As a result, users may be unable to interact with computer applications and related platforms, and/or with one another, in a desired fashion. Consequently, an enjoyment and productivity of such users may be limited, and full benefits of the computer applications and related platforms may fail to be realized.

### SUMMARY

According to one general aspect, a computer system may include instructions recorded on a computer-readable storage medium and readable by at least one processor. The system may include an input handler configured to cause the at least one processor to receive first human input events from at least one human input device and from at least one user, associate the first human input events with a first identifier, receive second human input events from the at least one human input device from the at least one user, and associate the second human input events with a second identifier. The system may include a command instructor configured to cause the at least one processor to relate the first human input events and the second human input events to commands of at least one application, and instruct the at least one application to execute the commands including correlating each executed command with the first identifier or the second identifier.

According to another general aspect, a computer-implemented method for causing at least one processor to execute instructions recorded on a computer-readable storage medium may include receiving first human input events from at least one human input device and from at least one user, associating the first human input events with a first identifier, and receiving second human input events from the at least one human input device from the at least one user. The method may further include associating the second human input events with a second identifier, relating the first human input events and the second human input events to commands of at least one application, and instructing the at least one application to execute the commands including correlating each executed command with the first identifier or the second identifier.

According to another general aspect, a computer program product may be tangibly embodied on a computer-readable medium and may comprise instructions that, when executed, are configured to cause at least one processor to receive first human input events from at least one human input device and from at least one user, associate the first human input events with a first identifier, receive second human input events from the at least one human input device from the at least one user, and associate the second human input events with a second identifier. The computer-implemented method may further relate the first human input events and the second human input events to commands of at least one application, and instruct the at least one application to execute the commands including correlating each executed command with the first identifier or the second identifier.

The details of one or more implementations are set forth in the accompanying drawings and the description below. Other features will be apparent from the description and drawings, and from the claims.

### BRIEF DESCRIPTION OF THE DRAWINGS

FIG. 1A is a block diagram of a first example system for cross-platform human input customization.

FIG. 1B is a block diagram of a second example system for cross-platform human input customization.

FIG. 2 is a flowchart illustrating example operations of the system of FIG. 1.

FIG. 3 is a flowchart illustrating more detailed example operations of the system of FIG. 1.

FIG. 4 is a block diagram of an example implementation of the system of FIG. 1 in which multiple input devices are combined into a single, larger input device.

FIG. 5 is a block diagram of an example implementation of the system of FIG. 1 in which multiple users interact with the same software application.

FIG. 6 is a block diagram of a second example implementation of the system of FIG. 1 in which multiple users interact with the same software application.

FIG. 7 is a block diagram of an example implementation of the system of FIG. 1 in which multiple users interact with two or more software applications.

FIG. 8 is a block diagram of a second example implementation in which multiple users interact with two or more software applications.

FIG. 9 is a block diagram illustrating multi-user, different application semantics scenarios.

FIG. 10 is a block diagram illustrating multi-user, same application semantics scenarios.

### DETAILED DESCRIPTION

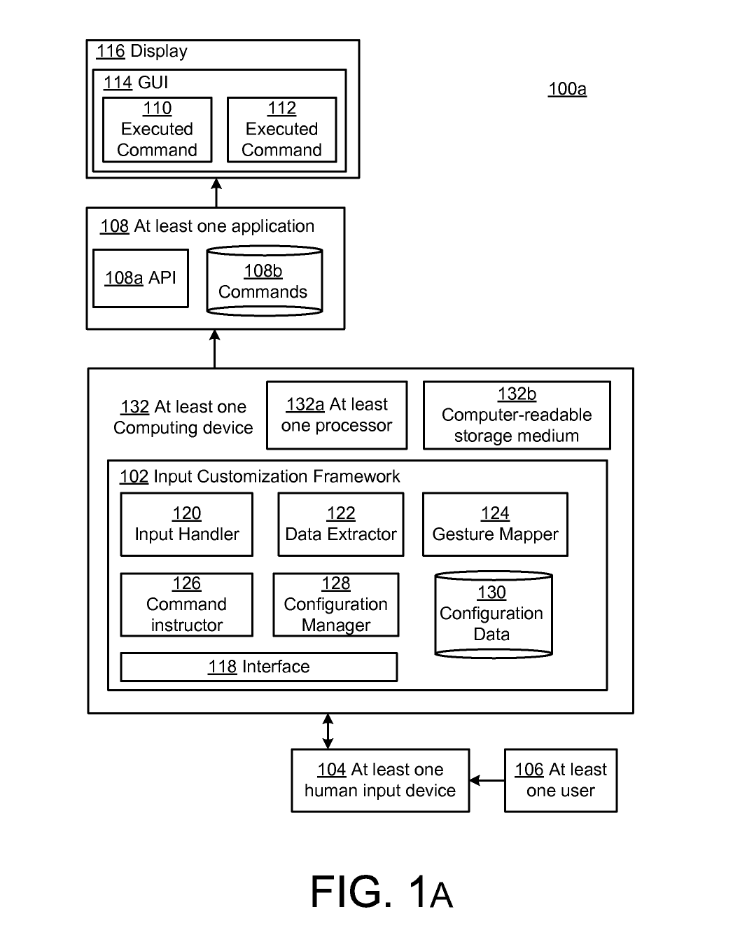

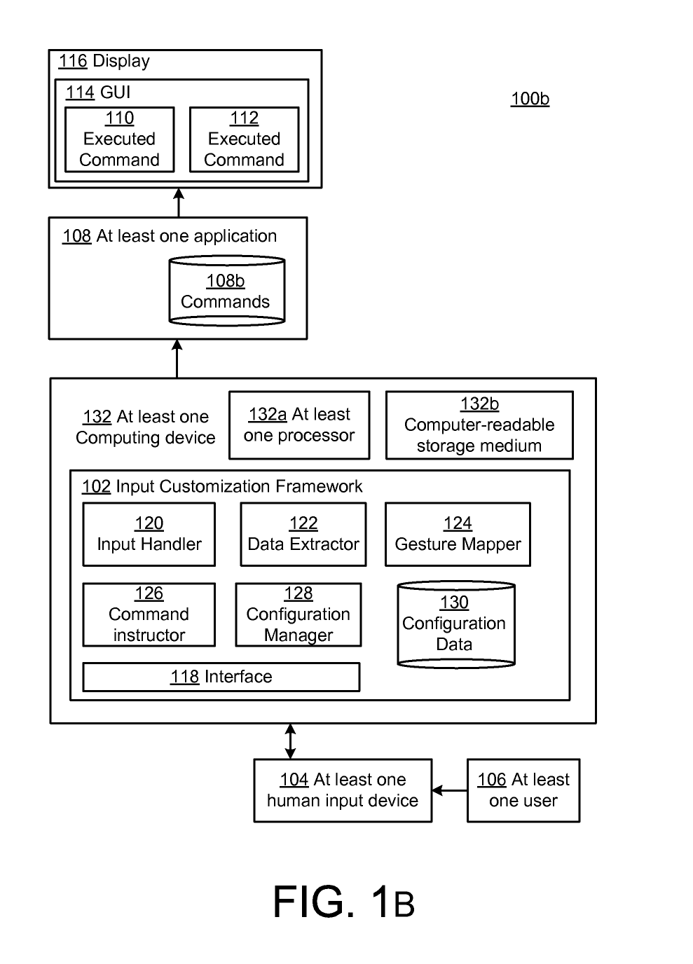

FIGS. 1A and 1B are block diagrams of a system(s) 100 for providing cross-platform human input customization. In particular, a cross-platform input customization framework 102 (also referred to herein as “framework 102”) may be configured to interact with at least one human input device 104, to thereby provide at least one user 106 with desired input functionality with respect to at least one application 108.

More specifically, as described in detail below, the framework 102 may be configured to capture and/or otherwise utilize raw input data received from the at least one human input device 104 and representing input actions of the at least one user 106. The framework 102 may thereafter relate such received data to native functionalities of the application 108, so as to thereby provide resulting executions of application commands, as represented by executed commands 110, 112 of FIGS. 1A, 1B.

Accordingly, the framework 102 may enable the at least one user 106 to obtain the executed commands 110, 112, in a manner which may not otherwise be supported or provided by the at least one human input device 104 and/or the at least one application 108. Moreover, as also described in detail below, the framework 102 may enable the at least one user 106 to configure and otherwise customize such functionalities in a desired fashion, and in a manner which is flexible and convenient.

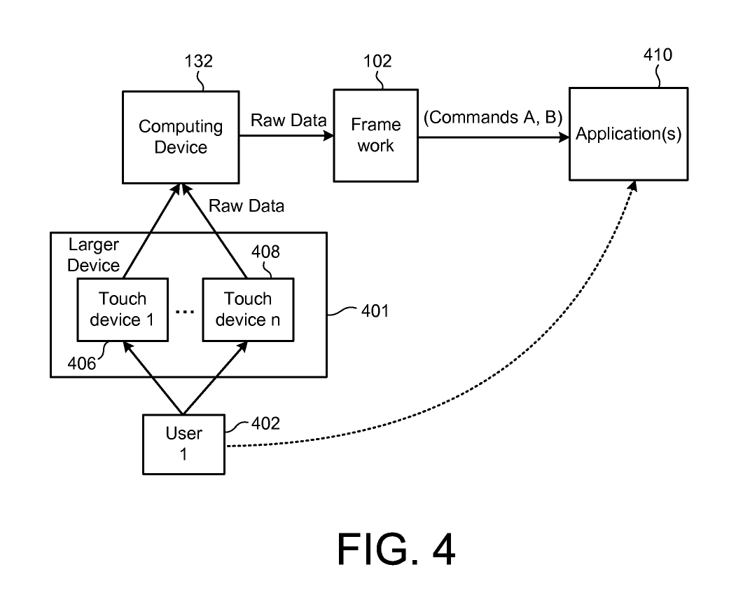

In the example of FIGS. 1A, 1B, as illustrated and described below in detail (e.g., with respect to FIGS. 4-8), the at least one human input device 104 may be understood to represent one, two, or more of any device or devices (or combinations and/or portions thereof, as described below with respect to FIG. 4) designed to capture a movement or other action of the at least one user 106, and to thereafter transform, represent, and/or otherwise provide the captured user action as data which may be stored or transmitted in electronic form. In the following description, such data may be referred to as raw data or captured data, and may generally be understood to represent human input events corresponding to movements or other actions of the at least one user 106. In other words, such raw data may be understood to represent data captured by the at least one human input device 104 and represented only or primarily with respect to features and functions of the at least one human input device 104, e.g., without respect to any particular software application and/or computing platform, or any specific functionalities thereof.

For example, as may be understood from the above description, the at least one human input device 104 may represent a multi-touch device (e.g., touch screen) which is designed to capture finger movements (and combinations thereof) of the at least one user 106. More specifically, for example, such multi-touch devices may include a capacitive touch screen which detects the various finger movements and combinations thereof, and captures such movements/combinations as positional data defining movements of the user's fingers (or other body parts or pointing elements) in a two dimensional plane defined by the capacitive touch screen. In other words, the resulting raw data captured by the at least one human input device 104 may provide (X, Y) coordinates of the finger movements/combinations (or X, Y, Z coordinates in the case of 3-dimensional devices), with respect to a frame of referenced defined by the at least one human input device 104 (i.e., the touch screen) itself.

It will be appreciated that many other types and variations of human input devices may be used, as well. For example, the touchscreens just referenced may be configured to interact with other parts of the user besides the user's fingers. Moreover, motion-sensing devices may be used to detect/track user movements/gestures or other actions. Still further, some devices may use appropriate optical techniques to track current body movements of a user, irrespective of any device (or lack thereof) being held, touched, or otherwise directly accessed by the user. In these and various other implementations, detected body movements may be mapped to corresponding gestures and ultimately to corresponding application commands and associated functions/actions.

During normal or conventional operations of these and other human input devices, captured raw data may be encapsulated for transmission and/or storage, using a standard and/or proprietary protocol. More particularly, for example, the resulting encapsulated data may conventionally be processed in the context of an operating system used to implement one or more applications designed to interact with the conventional multi-touch touch screen and/or other human input device(s), such as those just referenced. For example, in such conventional contexts, such human input devices may be utilized to control movement of a cursor within and across a desktop environment and/or multiple applications executing in the same operating context as the desktop environment.

In the example of the system 100 of FIGS. 1A, 1B, however, the raw data captured by the at least one human input device 104 may be obtained and utilized by the framework 102 in a manner which is partially or completely independent of an operating system (not specifically illustrated in the example of FIGS. 1A, 1B) which underlies the at least one application 108. Consequently, by obtaining and utilizing the raw data captured by the at least one human input device 104 in this manner, the framework 102 may be configured to transform the human input events received from the at least one user 106 into the executed commands 110, 112 of the at least one application 108. In this way, the framework 102 may be configured to provide flexible and configurable use of the at least one human input device 104 across a plurality of software applications and/or associated computing platforms, possibly in combination with two or more such human input devices and/or in conjunction with two or more collaborating users. Various examples of such variations and implementations of the framework 102 are illustrated and described below, e.g., with respect to FIGS. 4-10.

Although the just-provided examples discuss implementations of the at least one human input device 104 including one or more multi-touch interactive touch screens, motion-sensing devices, or touchless interactive devices, or other human input devices (or combinations thereof), it may be appreciated that the at least one human input device 104 may represent virtually any such device designed to capture movements or other actions of the at least one user 106. For example, a touch pad or other touch-based device may be utilized as the at least one human input device 104. In still other examples, the at least one human input device 104 may represent hardware and/or software used to capture spoken words of the at least one user 106, and to perform voice recognition thereon in order to obtain raw data representing the spoken words of the at least one user 106. Still further, as referenced above, the at least one human input device 104 may represent a device designed to track three dimensional movements of the at least one user within a space surrounding at least one user 106. Of course, the at least one human input device 104 also may represent various other conventional input devices, such as, e.g., a mouse, a keyboard, a stylus, or virtually any other known or not-known human input device.

Nonetheless, for the sake of simplicity and conciseness of explanation, the following description is provided primarily in the context of implementations of the at least one human input device 104 which include a multi-touch interaction screen/surface. Consequently, the executed commands 110, 112 of the at least one application 108 are illustrated as being displayed within the context of a graphical user interface (GUI) 114 provided on a display 116 (which may itself represent virtually any known or not-yet known display, including, e.g., a LCD or LED-based monitor of a laptop, netbook, notebook, tablet, or desktop computer, and/or a display of a Smartphone or other mobile computing device). Thus, in this context, the GUI 114 may be understood to represent, e.g., a proprietary or customized user interface of the at least one application 108, or, in other example embodiments, a more general or generic user interface, such as a conventional web browser.

Meanwhile, the at least one application 108 may be understood to represent, for example, an application running locally to at least one computing device 132 associated with the display 116 (as described in more detail below). In additional or alternative examples, the at least one application 108 may be understood to represent a remote application, e.g., a web-based or cloud application which is accessed by the at least one user 106 over the public internet or other appropriate local or wide area network, (e.g., a corporate intranet).

Thus, although operations of any and all such applications may be understood to be represented and displayed within a graphical user interface such as the GUI 114 of the display 116, it may nonetheless be appreciated that the executed commands 110, 112 may be provided in other appropriate contexts, as well. For example, the at least one application 108 may be configured, at least in part, to provide audible, haptic, or other types of output, in addition to, or as an alternative to, the type of visual output provided within the display 116. For example, the executed command 110 may include or represent an audible sound provided within the context of the GUI 114 by the at least one application 108. In other examples, the executed command 110 may represent a haptic output (e.g., a vibration) of a controller device used by the at least one user 106 (including, possibly, the at least one human input device 104 as such a controller).

In the example of FIG. 1, the framework 102 includes an interface 118 which generally represents hardware and/or software which may be configured to communicate with the at least one human input device 104. That is, as described above, the at least one human input device 104 may be configured to output information related to the movements or other actions of the at least one user 106, either as raw data and/or as encapsulated data transmitted using a known and/or proprietary protocol. Thus, in the example of FIGS. 1A, 1B, the interface 118 may be configured to receive any or all such communications from the at least one human input device 104, for subsequent use of the raw data obtained thereby by the framework 102 in order to instruct the at least one application 108 to provide the executed commands 110, 112, based on the input events received from the at least one user 106 by way of the at least one human input device 104.

To give specific, non-limiting examples, the at least one human input device 104 may be configured to communicate using Bluetooth or other wireless communication techniques with connected computing devices (e.g., with operating systems thereof). In such contexts, then, the interface 118 may represent hardware and/or software designed to intercept or otherwise obtain such wireless communications, to thereby obtain the raw data related to the human input events received from the at least one user 106, for use thereof by the framework 102. For example, the interface 118 may represent, or be included in, a hardware dongle which may be connected to an appropriate port of the at least one computing device 132.

In other specific examples, it may occur that the at least one human input device 104 is connected to the at least one computing device 132 by a wired connection (e.g., by way of a universal serial bus (USB) connection). In such contexts, the interface 118 may represent, or be included in or provided in conjunction with, an appropriate device driver for the at least one human input device 104 executing in the context of the at least one computing device 132.

Thus, in these and other example scenarios, the interface 118 illustrates that the framework 102 may be configured to interact and communicate with the at least one human input device 104, or at least to receive and utilize communications therefrom. In some example implementations, the at least one human input device 104 may continue any standard or conventional communications with any computing devices connected thereto, including, potentially, the at least one computing device 132 itself, in parallel with the above-referenced communications of the at least one computing device 132 with the interface 118 of the framework 102. In other example embodiments, the communications of the at least one human input device 104 with the interface 118 may preempt or supersede any standard or conventional communications of the at least one human input device 104 (e.g., the interface 118 may be configured to block any such communications which may be undesired by the at least one user 106 and/or which may interfere with operations of the framework 102).

Thus, by way of the interface 118, an input handler 120 of the framework 102 may be configured to receive the output of the at least one human input device 104. For example, in the specific examples referenced above, the input handler 120 may receive Bluetooth or other wireless packets transmitted by the at least one human input device 104. Similarly, the input handler 120 may be configured to receive corresponding packets received via a hardwired connection with the interface 118, as would be appropriate, depending upon a nature and type of such a connection. Consequently, it may be appreciated that the input handler 120 is extensible to a variety of different devices, including devices not specifically mentioned here and/or future devices.

In example scenarios in which a plurality of distinguishable streams of raw data representing separate sets of human input events are received at the input handler 120, the input handler 120 may be configured to assign corresponding identifiers to the separate/distinguishable streams of human input events. For example, as described in more detail below, and as referenced above, the at least one human input device 104 may represent two or more such human input devices. For example, a plurality of such human input devices may be used by a single user (e.g., using a left and right hand of the user), and/or using two or more users, with each of the two or more users utilizing a corresponding human input device of the at least one human input device 104. Still further, it may occur that a plurality of users of the at least one user 106 wish to collaborate using the at least one application 108.

In these and other example scenarios, some of which are described in more detail below, the input handler 120 may be configured to assign a unique identifier to data received from the corresponding stream of human input events. For example, in various ones of the above examples, an individual identifier may be assigned to each of two or more users of the at least one user 106. Similarly, such an identifier may be assigned to the raw data representing two or more interactive touch surfaces (and/or representing a defined subset or subsets of such interactive touch surfaces).

A data extractor 122 may be configured to extract the raw data from such packets, and/or to otherwise obtain such raw data as included within the standard and/or proprietary protocol used by the at least one human input device 104 for outputting human events received from the at least one user 106. As referenced above, such standard or conventional communications of the at least one human input device 104 utilizing a standard transmission protocol to encapsulate or otherwise transform raw data captured from the at least one user 106 may be configured to enable execution of the at least one human input device 104 as part of a process flow of an operating system of the at least one computing device 132. In other words, standard or conventional communications received from the at least one human input device 104 may already be configured to be processed by the operating system of the at least one computing device 132 across a plurality of supported applications. However, as also described in reference to the above, such communications and associated processing, by themselves, may limit a flexibility and configurability of the at least one human input device 104, particularly across two or more applications and/or in the context of collaborations among two or more users, and/or across two or more of the (same or different implementations of) the at least one human input device 104.

To give but a few specific examples, it may occur the at least one application 108 was designed for use with a keyboard and mouse, and may have limited native functionality or ability to interact with a multi-touch surface as the at least one human input device 104 (e.g., may not recognize gestures). Conversely, the at least one application 108 may have been designed specifically for use in the context of such multi-touch interactive touch screens, and consequently may not be fully functional within a context in which only a keyboard or mouse are available as the at least one human input device 104.

Moreover, even when the at least one application 108 is, in fact, designed for use with a multi-touch interactive touch screen (or other desired type of human input device), the above-referenced and other conventional/standard implementations may be insufficient or otherwise unsatisfactory. For example, it may be observed in conventional settings that it may be difficult or impossible to enable multiple human input devices 104 in the context of an application such as the at least one application 108. For example, plugging two mouse devices and/or a mouse and touch pad into a single computing device and associated operating system typically results in a preempting of the desired functionality by only a single one of the two or more attached human input devices at a given time, (for example, two mouse devices plugged into a single computer typically results in cursor control by only one of the devices, at least at a given time).

In contrast, as described herein, the framework 102 may utilize raw data captured by the at least one human input device 104 (as received by way of the interface 118, the input handler 120, and the data extractor 122, if necessary). Thus, the framework 102 may be configured to instruct the at least one application 108 to provide the desired executed commands 110, 112, in a manner which is independently configurable across a plurality of applications represented by the at least one application 108.

For example, in the example of FIGS. 1A, 1B and in the specific, non-limiting example context described herein in which the at least one human input device 104 includes a multi-touch interactive touch surface, the raw data obtained by the data extractor 122 may generally represent movements and other actions of fingers of the at least one user 106, or combinations thereof. For example, the extracted raw data may represent a position, movement, velocity, pressure, or other aspects, or combinations thereof, of finger motions of the at least one user 106. As a result, such motions, and combinations thereof, may be understood to represent gestures which are defined according to combinations or subsets of such finger motions. Similar comments would thus be understood to apply in the context(s) of the various other types of human input devices referenced herein (e.g., touchless devices, motion-sensing devices, or voice-recognition devices). Consequently, the framework 102 includes a gesture mapper 124 which may be configured to examine the extracted raw data from the data extractor 122, and to correspond the represented motions and actions of the fingers of the at least one user 106, and thereby correlate such motions/actions with specific gestures.

Of course, such gestures may include some standard gestures known to be associated with multi-touch interactive touch surfaces (e.g., including a “pinch” gesture and/or a “spread” gesture, which may be used to zoom out and zoom in, respectively, in the context of visual displays). However, as already described and referenced above, such standard usages of gestures may typically already be encapsulated and represented in a potentially proprietary format and in a manner designed to interact with an operating system of the at least one computing device 132.

Consequently, since the framework 102 utilizes raw data captured by the at least one human input device 104 and extracted by the data extractor 122, it may be necessary or desirable for the framework 102 to independently obtain or otherwise characterize corresponding gestures. Moreover, as described in more detail below, the framework 102 may be configured to provide user-selectable gesture mappings, which may not otherwise be available in standard or conventional uses of the at least one human input device 104.

Using the resulting gestures, a command instructor 126 may be configured to instruct the at least one application 108 to provide the desired, executed commands 110, 112 corresponding to the finger motions/actions of the at least one user 106 at the at least one human input device 104. For example, in the example of FIG. 1A, it may occur that the at least one application 108 includes an application program interface (API) 108a, which is provided by a developer of the at least one application 108 for use by code developers and/or independent developers in modifying or otherwise interacting with the at least one application 108. Moreover, as also shown, the at least one application 108 may include or be associated with a plurality of application commands 108b, which represent all relevant commands included in, or associated with, the program code of the at least one application 108. In other example implementations, illustrated in FIG. 1B, the API 108A need not be included (e.g., need not be provided by the developer of the application 108). Instead, the application 108 may simply include typical commands 108b (e.g., that may be executed via a mouse, keyboard, or other HIDs, or combinations thereof).

Of course, such native commands may vary considerably depending on a type and nature of the at least one application 108. For example, the at least one application 108 may include a map application designed to provide geographical maps. In such contexts, the command 108b may include various map-related commands for interacting with the location map provided by the at least one application 108. In other example context, the at least one application 108 may include a video game, in which case the various command 108b may be configured for specific actions of characters within the video game in question.

Thus, in FIG. 1A, the at least one application 108 may provide the API 108a as a means for interacting with the command instructor 126. Consequently, the command instructor 126 may be configured to instruct the API 108a to cause the at least one application 108 to execute a specified one of the command 108b, and thereby obtain, e.g., the executed command 110. In the example of FIG. 1B, when a provider (e.g., developer) of the framework 102 wishes to enable the application 108 with the at least one human input device 104, the provider may provide a gesture mapping file in framework 102 (e.g., in configuration data 130 as described herein) which maps a particular gesture to an arbitrary mouse or keyboard action (or combination of both) which is then injected into the application 108 afterwards (i.e., after each data frame from the data stream or after the gesture has been completed (e.g., when drawing a circle as a gesture)). Thus, the gesture mapper 124 may be understood, in conjunction with the command instructor 126, to map a syntax of a received gesture from a specified user to a syntax of the application, where the application 108 may be understood to define possibilities for semantics of its associated commands 108b.

As referenced above with respect to the input handler 120, it may occur that the raw data obtained from the at least one human input device 104 may include a plurality of data streams representing corresponding sets of human input events. In such scenarios, the command instructor 126 may be configured to instruct the at least one application 108 (e.g., using the API 108a in FIG. 1A or by direct injection in the example of FIG. 1B) to execute the executed commands 110, 120 in a manner which visibly or otherwise corresponds to, and demonstrates, the previously-assigned identifiers. For example, as described above, the example system 100 of FIGS. 1A, 1B may include two or more users using a single human input device, and/or a plurality of the at least one human input device 104 being utilized by one or more of the at least one user 106.

Consequently, since the command instructor 126 may be provided with gestures from the gesture mapper 124 in a manner which detects the associated identifiers provided therewith, the command instructor 126 may instruct the at least one application 108 to provide the executed commands 110, 112 in a manner which also reflects the corresponding identifiers. For example, in a simple scenario, it may occur that the at least one user 106 represents two collaborating users, using the at least one human input device 104. In such scenarios, the executed command 110 may represent a command desired by a first user, while the executed command 112 may represent a command desired by the second user.

In such scenarios, the command instructor 126 may further instruct the at least one application 108 to display the executed commands 110, 112 in a manner which reflects the correspondence thereof to the associated identifiers, and thus to the users in question. Specifically, for example, the first user may be associated with a first color, while the second user may be associated with the second color, so that the executed commands 110, 112 may be provided in the colors which correspond to the pair of hypothetical users.

Additional examples of manners in which the assigned identifiers may be utilized by the command instructor 126 are provided below, e.g., with respect to FIGS. 4-8. Nonetheless, from the above description, it may be appreciated that the framework 102 provides the at least one user 106, including two or more collaborating users, with the ability to obtain desired executed commands 110, 112, virtually irrespective of a type or number of the at least one human input device 104 to be used, and/or irrespective of a native functionality of the at least one application 108 in communicating with such potential human input devices.

As referenced above with respect to the gesture mapper 124, the command instructor 126 may be flexibly configured so as to provide specific instructions to the at least one application 108 in a manner desired by the at least one user 106 (or other user or administrator). Specifically, as shown, a configuration manager 128 of, or associated with, the framework 102 may be accessible by the at least one user 106 or other user/administrator. Thus, the configuration manager 128 may be configured to store, update, and otherwise manage configuration data 130 which may be utilized to configure a manner and extent to which the raw data from the data extractor 122 is mapped to specific gestures by the gesture mapper 124, and/or a manner in which the command instructor 126 translates specifying gestures received from the gesture mapper 124 for instruct based thereon to the at least one application 108 to provide the executed commands 110, 112 as instances of corresponding ones of the command 108B.

Of course, such configuration options may extend across the various types of human input devices which are compatible with the system 100, as referenced above. For example, it may occur that the at least one human input device 104 outputs raw data, so that the input handler 120 may directly output such raw data to the gesture mapper 124, so that, in these examples, the data extractor 122 is not required.

Somewhat similarly, it is referenced above that the example of FIGS. 1A and 1B and related examples contemplate use of a multi-touch interactive touch surface as the at least one human input device 104. However, as also referenced, many other types of human input events may be received. For example, human input events may be received corresponding to voice recognition, in which case the gesture mapper 124 may be partially or completely omitted, and the command instructor 126 may proceed with correlating received input events with desired ones of the commands 108b, to thereby obtain the executed commands 110, 112. More particularly, with reference to FIGS. 1A and 1B, it may be appreciated that the existence of the API 108a may enable direct forwarding of gesture data to the application 108 in FIG. 1A, whereas FIG. 1B may rely more explicitly on data flow between the data extractor 122, the gesture mapper 124, and the command instructor 126, as described herein.

Although the above explanation illustrates a manner(s) in which conventional human input devices execute as part of a process flow of an operating system, and provides explanation and discussion with respect to interactions with the at least one application 108 that are independent of an operating system, it may be appreciated that the framework 102 also may, if desired, interact with an operating system of the device 132. For example, the command instructor 126 may instruct the at least one application 108 including an operating system thereof, to thereby provide the desired executed command 110. Thus, it may be observed that the framework 102 may be configured to interact with the operating system of the at least one computing device 132, if desired, but that such operations may themselves be independent or separable from command instructions provided to other applications and/or operating systems.

As shown in FIGS. 1A, 1B, and as referenced above, the framework 102 is illustrated as executing in the context of at least one computing device 132. As also shown, the at least one computing device 132 may include at least one processor 132a, and associated computer readable storage medium 132b. Thus, the computer readable storage medium 132b may be configured to store instructions which, when executed by the at least one processor 132a, results in execution of the framework 102 and associated operations thereof.

Thus, for example, it may be appreciated that two or more subsets of components of the framework 102 may be executed using two or more computing devices of the at least one computing device 132. For example, portions of the framework 102 may be implemented locally to the at least one user 106, while other portions and components of the framework 102 may be implemented remotely, e.g., at a corresponding web server.

Somewhat similarly, it may be appreciated that any two or more of the components of the framework 102 may be combined for execution as a single component. Conversely, any single component of the framework 102 may be executed using two or more subcomponents thereof. For example, the interface 118 may be implemented on a different machine than the remaining components of the framework 102. In other implementations, the interface 118 and the input handler 120 may be executed on a different machine than the data extractor 122, the gesture mapper 124, the command instructor 126, and the configuration manager 128. More generally, similar comments apply to remaining components (122-126) as well, so that, if desired, a completely distributed environment may be implemented.

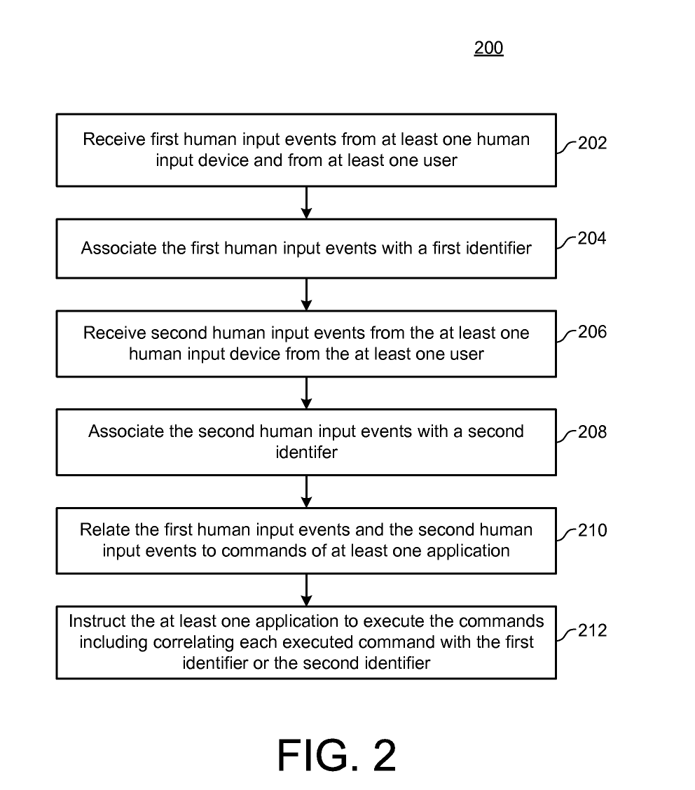

FIG. 2 is a flowchart 200 illustrating example operations of the system 100 of FIGS. 1A, 1B. In the example of FIG. 2, operations 202-212 are illustrated as separate, sequential operations. However, it may be appreciated that in alternative implementations, two or more of the operations 202-212 may be implemented in a partially or completely parallel or overlapping manner, and/or in a nested, iterative, or looped manner. Further, operations may be performed in a different order than that shown, and additional or alternative operations may be included, and/or one or more operations may be omitted.

In the example of FIG. 2, first human input events may be received from at least one human input device and from at least one user (202). For example, the input handler 120 of the framework 102 may be configured to receive raw data from the at least one input device 104, as inputted by the at least one user 106. As described, such raw data may include data representing transduced representations of physical motions or other actions of the at least one user 106 with respect to the at least one input device 104.

The first human input events may be associated with a first identifier (204). For example, the input handler 120 may be configured to associate a first identifier with all input events received from a first user of the at least one user 106, and/or from a first human input device (or defined portion or aspect thereof) of the at least one input device 104.

Similarly, second human input events may be received from the at least one human input device and from the at least one user (206), and the second human input event may be associated with a second identifier (208). For example, the input handler 120 may receive raw data from the at least one human input device 104 that is associated with the second user of the at least one user 106, and may associate a second identifier therewith. In other example embodiments, the first and second human input events may be received from a single user, e.g., such as when the input events are received from a left hand and a right hand of the same user (e.g., such as when each hand is used in conjunction with a separate input device), or from a finger of the user in conjunction with voice-recognized input events and/or 3-dimensional movements of the user. Further, although the examples just given refer to reception of raw data by the input handler 120, it may be appreciated that, as described above, the input handler 120 may receive encapsulated data from the at least one human input device 104 by way of the interface 118, and may require the data extractor 122 to extract the raw data from its encapsulation within packets defined by a relevant transmission protocol.

Further with respect to FIG. 2, the first human input events and the second human input events may be related to commands of at least one application (210). For example, the command instructor 126 of FIGS. 1A, 1B may be configured to relate the first and second human input event to the at least one application 108 and associated commands 108b associated therewith. For example, as described in detail herein, the configuration manager 128 of FIGS. 1A, 1B may be configured to enable the at least one user 106 (or other authorized personnel) to relate some or all of the individual commands of the commands 108b to corresponding human input events or types of human events (or related interpretations thereof, e.g., gestures) that might be received at the at least one human input device 104.

That is, for example, in examples described herein in which the at least one input device 104 includes a multi-touch surface, the received human input events may initially be mapped to specific gestures, where such mappings also may be configured utilizing the configuration manager 128. Then, defined gestures may be related by the command instructor 126 to corresponding, individual ones of the command 108b. However, in other example implementations, such definitions and related mappings of gestures may not be relevant. For example, where the at least one human input device 104 includes voice recognition, recognized words or phrases from the at least one user 106 may be related directly to individual, corresponding ones of the commands 108b, without need for an immediate gesture mapping by the gesture mapper 124.

The at least one application may be instructed to execute the commands including correlating each executed command with the first identifier or the second identifier (212). For example, the command instructor 126 may be configured to communicate with the API 108a of the at least one application 108, as in FIG. 1A. In such cases, the API 108a may be instructed to assign the commands 110, 112 to the different users. Alternatively, as in FIG. 1B, the command instructor 126 may directly cause execution of desired commands 110, 112, without requiring the API 108a. In this case, the different commands 110, 112 may be executed for the different users, but the different commands 110, 112 are assigned to the respective users in the command instructor 126 and/or the gesture mapper 124. In the latter regard, such user dependency may be realized within the gesture mapper 124, so that, for example, human input events may be used to recognize user-specific gestures. Consequently, as described herein, different gestures may be correlated with the same or different commands for the same or different human input events. Thus, for example, it is possible to have a user-preferred gesture for the same intended result in the application 108. In any case, as also described, it is possible to causes the at least one application 108 to provide the executed command 110 in a manner which demonstrates a correspondence thereof to the first identifier, and thereby to the first human input event, while similarly providing the executed command 112 in a manner which demonstrates correspondence thereof to the second identifier, and thereby to the second human input event.

For example, as described in more detail herein, in the example of FIG. 1B in which the executed commands 110, 112 are provided in the context of the GUI 114 of the display 116, a visual aspect of each command (e.g., a color or other appearance thereof) may be provided in a manner which demonstrates correspondence of the executed command to the first human input event stream, and the second executed command 112 to the second human input event stream. In other examples, correspondence of the executed commands 110, 112 with the respective first and second human input events may be demonstrated using other techniques, e.g., including providing different audible sounds in conjunction with execution of the executed commands 110, 112 and corresponding respectively to the first and second human input events.

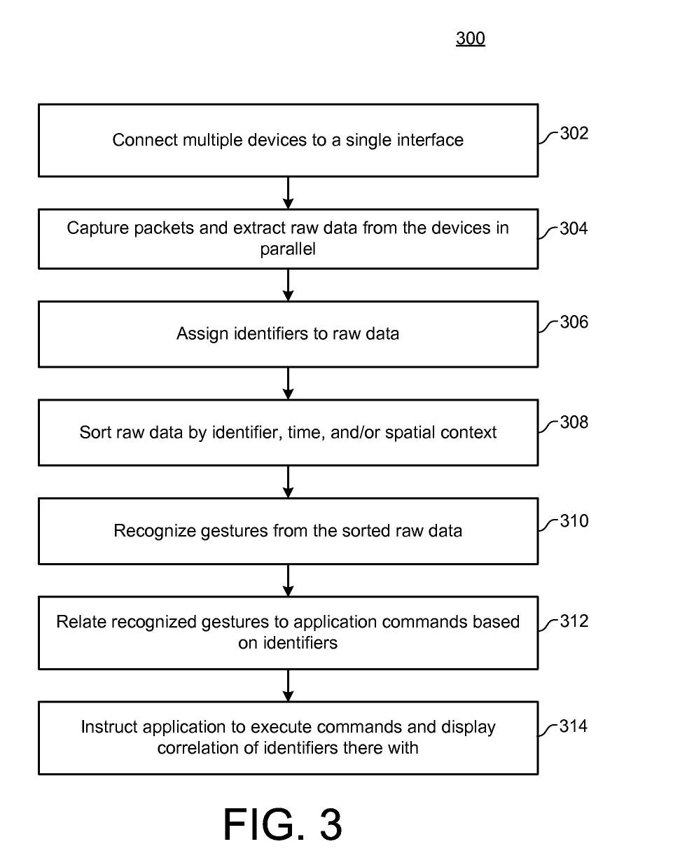

FIG. 3 is a flowchart 300 illustrating more detailed example operations of the system 100 of FIGS. 1A, 1B. More specifically, in the described examples of FIG. 3, at least two multi-touch touch surfaces (or at least two sub areas of at least one multi-touch touch surface) may be understood to be represented by the at least one human input device 104 of FIGS. 1A, 1B. Further, additional specific examples in these and related context are provided and illustrated below with respect to FIGS. 4-8.

In the example of FIG. 3, it is assumed that the configuration data 130 has been provided which maps specific human input events to corresponding gestures (as implemented by the gesture mapper 124), and which relates resulting gestures to individual ones of the commands 108b of the at least one application 108. As described, the configuration data may be provided in whole or in part, e.g., by a provider or developer of the framework 102 and/or a provider/developer of the at least one application 108, as well as by the user 106. For example, a provider of the framework 102 may pre-configure the configuration data 130 so as to enable the framework 102 to support interactions with specific applications or computing platforms.

In other examples, as also described, the at least one user 106 may utilize the configuration manager 128 to modify, create, or otherwise provide the configuration data 130. For example, the configuration manager 128 may provide a graphical user interface (not explicitly illustrated in the example of FIGS. 1A, 1B) in which the at least one user 106 may select the at least one application 108 (or in which the application 108 is pre-selected), and may provide the at least one user 106 with the commands 108b (or a configurable subset thereof).

Similarly, the configuration manager 128 may utilize the above-referenced graphical user interface to provide a list of potential gestures, so that the at least one user 108 may input specific finger motions or other actions and then correlate such actions with specific ones of the provided gestures, or with newly defined and named gestures provided by the at least one user 106. For example, the configuration manager 128 may include a recording function which is configured to detect and store specified finger motions of the at least one user 106, whereupon the at least one user 106 may relate the recorded finger motion to specific existing or new gestures. Although the examples of FIGS. 3-8 are primarily provided with respect to multi-touch touch surfaces, it may be appreciated that such gesture mapping may also be conducted in other contexts. For example, cursor movements associated with movements of a mouse, trackball, other human input device may be recorded and stored in similar fashion, and therefore also may be mapped to specific existing or new gestures.

Further, as may be appreciated from the above description, the resulting gestures may be related to specific ones of the commands 108b (or configurable subsets thereof). For example, the commands 108b may include keyboard shortcuts or other specific functions of the application 108, so that the at least one user 106 may simply highlight or otherwise select such commands in conjunction with highlighting or otherwise selecting specific gestures which the user wishes to relate to the selected commands (or vice-versa).

Thus, in the example of FIG. 3, multiple devices may be connected to a single interface (302), such as when two or more of the at least one human input device 104 are connected to the interface 118. As described, the interface 118 may include a wireless interface (e.g., a Bluetooth interface) or may represent a driver or other appropriate software in communications with a hardwired connection to each of the multiple devices.

Packets may be captured from the devices in parallel, and raw data may be extracted therefrom (304) representing the various human input events associated with usage of the multiple devices. For example, the input handler 120 may capture Bluetooth packets, or packets formatted according to any relevant protocol in use, so that the data extractor 122 may proceed with the extraction of the raw data from any encapsulation or other formatting thereof which may be used by the relevant protocol. As described, such data capture and extraction may proceed with respect to the multiple input devices in parallel, so that, for example, two or more of the at least one user 106 may collaborate with one another or otherwise utilize and interact with the at least one application within the same or overlapping time periods.

Identifiers may be assigned to the captured raw data (306). For example, the input handler 120 may utilize an identifier which is uniquely associated with a corresponding one of the multiple input devices. Then, any communications received from the corresponding input device may be associated with the pre-designated identifier. In some examples, the identifier may be associated with the incoming data at a time of receipt thereof, and/or may not be associated with the raw data until after the raw data is extracted by the data extractor 122.

The raw data may be sorted, e.g., by the associated identifier, by time of receipt, and/or by spatial context (308). For example, the input handler 120 and/or the data extractor 122 may be provided with overlapping input events received as part of corresponding streams of human input events. To give a simplified example, it may occur that human input events from two users may alternate with respect to one another, so that the input handler 120 and/or the data extractor 122 may be provided with an alternating sequence of human input events, whereupon the input handler 120 and/or the data extractor 122 may be configured to separate the alternating sequence into two distinct data streams corresponding to inputs of the two users.

Similarly, various other criteria and associated techniques may be utilized to sort the received data. For example, as referenced, data received at a certain time or within a certain time window, and/or data received from within a certain area of one or more of the connected multi-touch interactive touch surfaces may be associated with particular input data streams, or subsets thereof. For example, a first user may be associated with a certain role and/or usage rights within a particular time window (e.g., may be designated in a presenter role at the beginning of a presentation). At the end of the designated time window, the same user may be provided with different access rights. Thus, in these and other examples, the gesture mapper 124 may be configured to process received data streams of human input events in a desired and highly configurable fashion.

Gestures may be recognized from the sorted raw data (310). For example, the configuration data 130 may be consulted by the gesture mapper 124 in conjunction with the received human input events, to thereby determine corresponding gestures.

The recognized gestures may thereafter be related to application commands, based on the identifiers (312). For example, the command instructor 126 may receive the recognized gestures, and may again consult the configuration data 130 to relate the recognized gestures to corresponding ones of the commands 108b. As described herein, the identifier associated with a particular data stream may dictate, to some degree, the determined relationship between the recognized gestures and the command 108b.

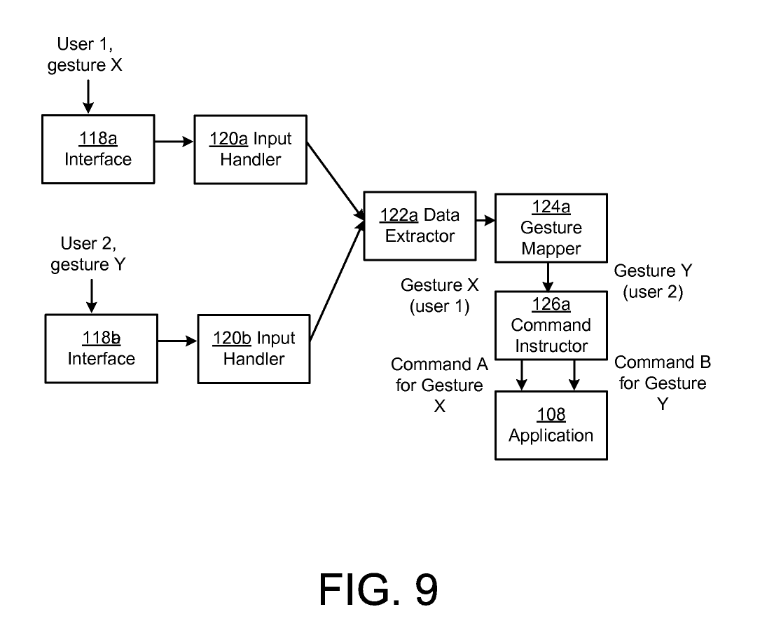

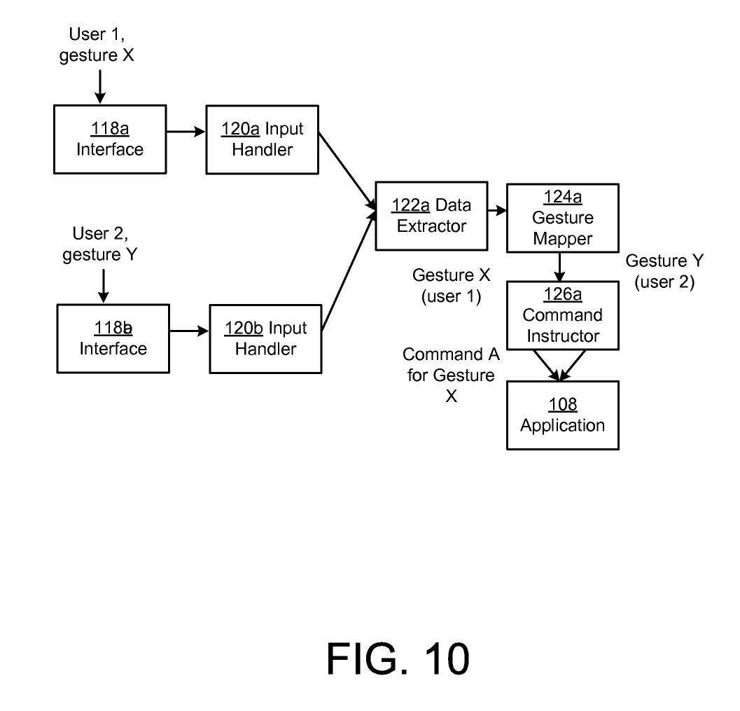

For example, as described, the first user may be associated with a first role and associated access/usage rights, so that gestures recognized as being received from the first user may (or may not) be related to the commands 108b differently than gestures recognized as being received from a second user. For example, the first user may have insufficient access rights to cause execution of a particular command of the commands 108b, so that the gesture mapper 124 and/or the command instructor 126 may relate a recognized gesture from the first user with a command stating “access denied,” while the same recognized gesture for the second user may result in the desired command execution on the part of the application 108. Additional examples are provided below with respect to FIGS. 9 and 10.

The application may be instructed to execute the related commands, and to display a correlation of corresponding identifiers therewith (314). For example, the command instructor 126 may be configured to instruct the application 108, via the API 108a, to execute corresponding commands of the commands 108b, and thereby obtain the executed commands 110, 112. In the example, the executed command 110 may be entered or requested by the first user, while the executed command 112 may be requested by the second user. In the example, the executed commands 110, 112 may therefore be displayed within the GUI 114 in different colors, or may otherwise be visually, audibly, or otherwise provided in a manner which demonstrates correspondence of the executed commands 110, 112 to the corresponding identifiers and associated input devices/users. In other examples, as described with respect to FIG. 1B, the API 108a need not be included, and the command instructor 126 may inject the desired commands directly for execution by the application 108, as described herein.

Of course, if desired, the framework 102 may be configured to provide the executed commands 110, 112 from corresponding first and second users in an identical manner to one another, so that the executed commands 110, 112 may be indistinguishable from the perspective of an observing party. Nonetheless, it may be appreciated that even in such scenarios, the framework 102 may retain data associated in the executed commands 110, 112 with corresponding identifiers/devices/users, e.g., for display thereof upon request of one or both of the users, or by any other authorized party.

FIGS. 4-8 are block diagrams illustrating various use cases and associated executed scenarios which may be implemented using the system 100 of FIGS. 1A, 1B. In the example of FIG. 4, a plurality of devices 406, 408 desired to be used in controlling the application 410 are logically combined into a larger device 401, using the framework 102. Specifically, as shown, the user 402 may interact with at least two touch devices 406, 408, each of which may be connected to the computing device 132 and the framework 102. Consequently, as described in detail herein, the framework 102 may be configured to receive, identify, and sort the corresponding distinct input streams from the different devices, 406, 408.

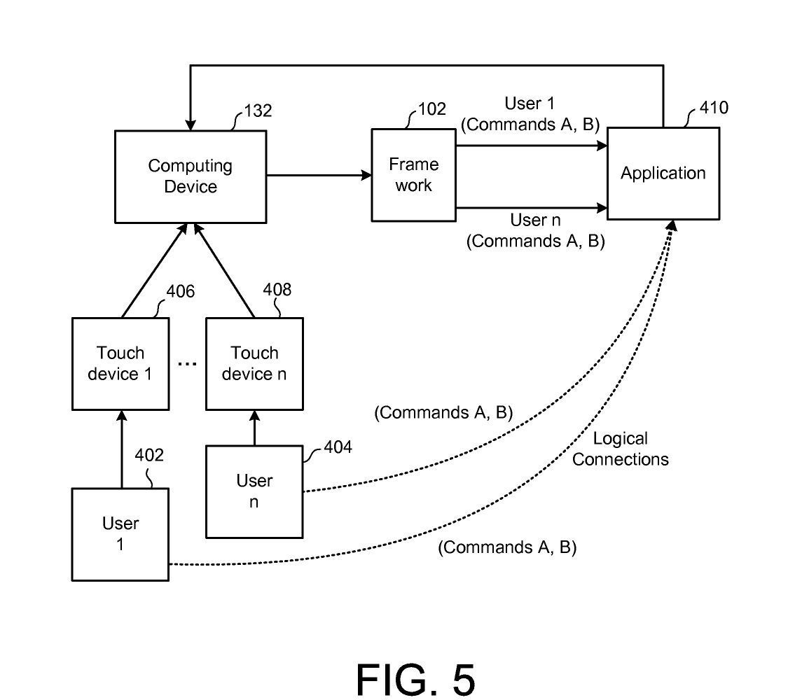

However, in the example of FIG. 4, the framework 102 may be configured to relate the raw data received from the devices 406, 408 to a conceptually existing larger frame of reference, e.g., defined by a combination of touch surface areas of the individual touch devices 406, 408. For example, with respect to FIGS. 1A, 1B, the framework 102 may be configured to detect a finger motion of the at least one user 106 which begins at the far left edge of the touch device 406 and extends all the way to a far right edge of the touch device 408 and is correspondingly traversing a total distance from a left edge of the GUI 114 to a right edge thereof. In this way, again, the user 402 may be provided with a highly flexible and configurable user experience. In particular, it may be appreciated that the at least one human input device 104 of FIGS. 1A, 1B, and with any of the devices that are described below with respect to FIGS. 5-10, may be understood to represent one or more devices logically constructed from two or more devices in the manner described above with respect to FIG. 4.

In FIG. 5, multiple users 402, 404 using corresponding touch-based input devices 406, 408 may interact with the same, single application 410. In the example of FIG. 5, specifically, the multiple users 402, 404 may interact with the same application 410 in a semantically equal or equivalent fashion. That is, as illustrated in FIG. 4, input actions and associated gestures received from any of the users 402, 404 may be related to corresponding commands of the application 410 in the same manner. That is, as shown, the same gestures received from the multiple users 402, 404 may be related to the same commands A, B of the application 410, thereby providing the same logical connection to each of the multiple users 402, 404. Thus, for example, the configuration data 130 may be the same, or may be accessed the same, for all users/input devices.

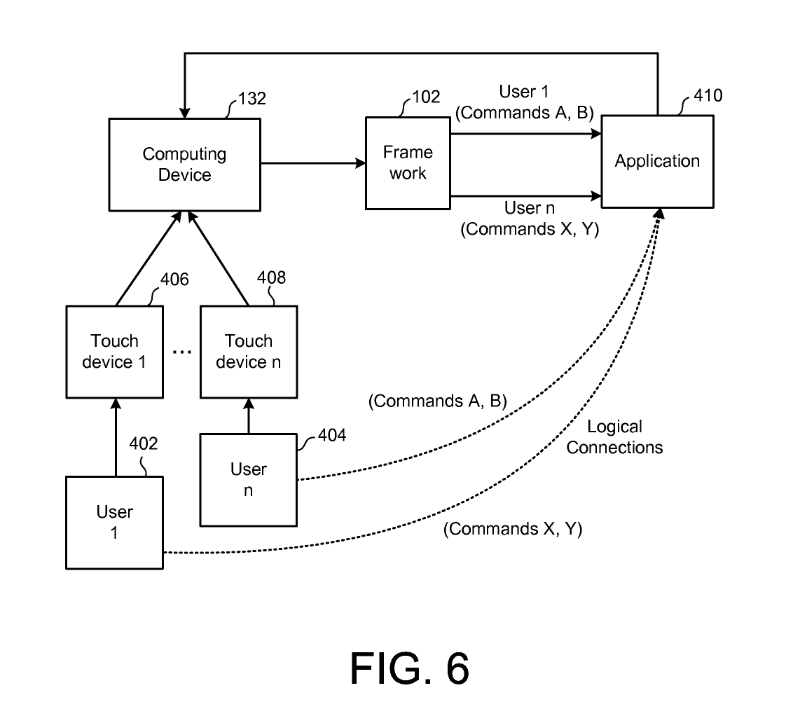

In contrast, FIG. 6 illustrates an alternate embodiment in which the input stream from the user 402/device 406 is related differently to application commands than the input stream from the user 404/device 408. That is, as shown, input identified as being received from the user 402/device 406 may be related in the example to commands A, B, while input received from the user 404/device 408 may be related to commands X, Y of the application 410. Consequently, as illustrated, different/separate logical connections may be established between the various users 402, 404 and the same application 410.

In the example of FIG. 6, then, it may be observed that the configuration data 130 may be different, or accessed differently, for the various users and associated devices. For example, a portion or subset of the configuration data 130 may be assigned to the user 402 and device 406, while a different portion or subset may be associated with the device 408 and the user 404. In this way, it may be appreciated that, even within a single/same application, user interactions therewith may be highly configurable. Consequently, for example, as referenced herein, different users may be associated with different roles, access rights, or other usages of the application 410.

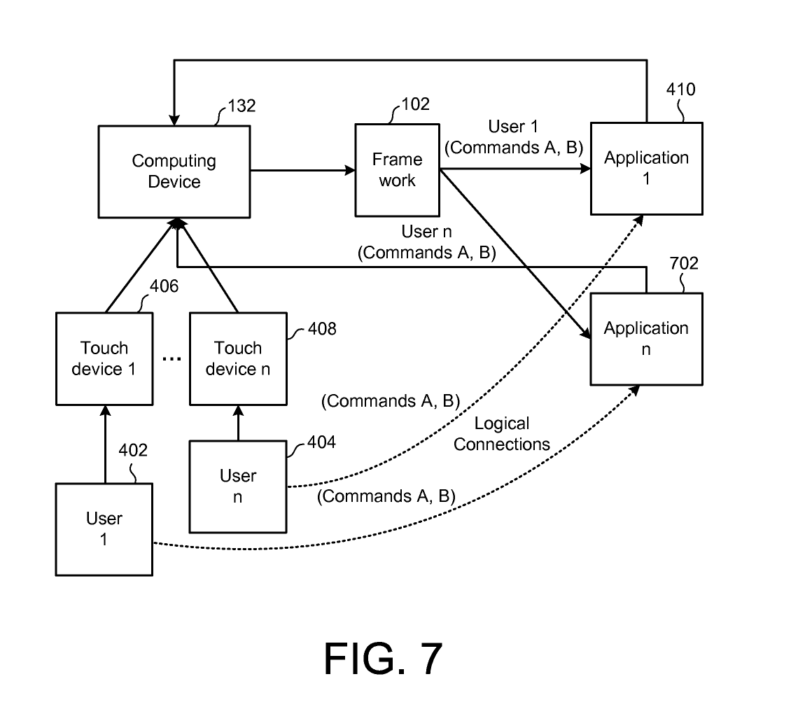

FIG. 7 illustrates an example embodiment which is conceptually related to the example of FIG. 5. In the example of FIG. 7, similarly to FIG. 5, the various users 402, 404, and respective devices 406, 408 are configured to be related to the same sets of commands, in the same way. However, in the example of FIG. 7, such configuration is carried out across a plurality of applications, illustrated in the example of FIG. 7 as the application 410 and at least one other application 702. Consequently, as shown in the specific example of FIG. 7, the same logical connections may be established between the various users 402, 404 and respective applications (or instances thereof) 410, 702. In this way, different users may be provided with a consistent user experience across various different applications.

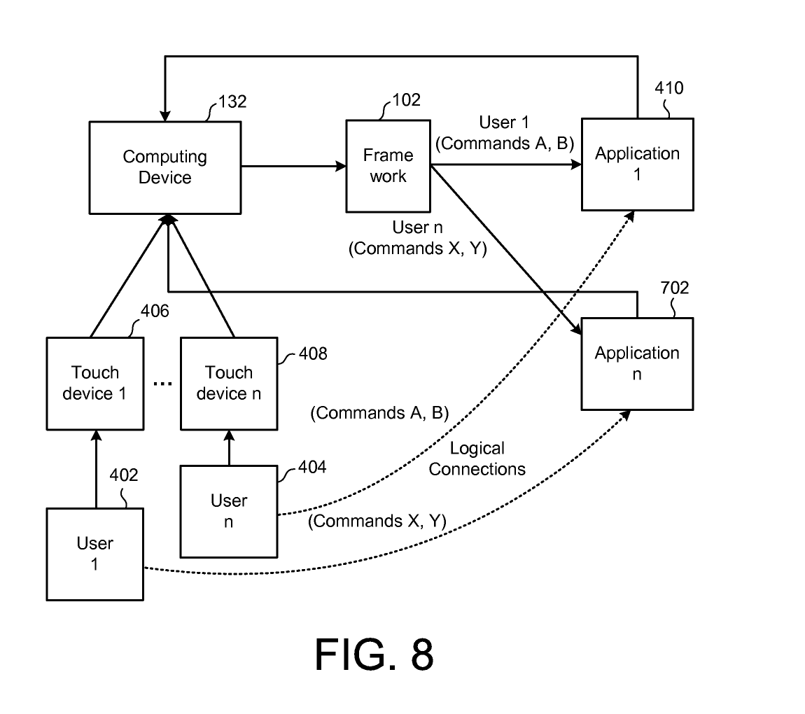

Meanwhile, FIG. 8 illustrates an example implementation which is conceptually related to the example of FIG. 6. In the example of FIG. 8, specifically, gestures or other inputs from the users 402, 404 and respective devices 406, 408 are related differently with respect to the different applications 410, 702 and associated commands thereof.

That is, as referenced above with respect to FIG. 6, different portions or subsets of the configuration data 130 may be configured such that a particular gesture received from the user 402 by way of the device 406 may be interpreted differently with respect to the application 410 (e.g., may result in instruction of execution of commands A, B), while the same gesture received from the user 404 by way of the device 408 may be related to the application 702 in a different manner (e.g., may be related to commands X, Y thereof). In this way, as shown, different logical connections may be provided with respect to the different users 402, 404 and the different applications 410, 702. In such scenarios, then, it may be appreciated that the various users 402, 404 may be provided with a highly configurable and selectable platform for interacting with a wide variety of applications in a desired manner.

FIG. 9 illustrates a more detailed example of scenarios in which two or more users are provided with user-dependent or user-specific gesture interpretation in conjunction with correspondingly different application semantics, in the context of FIG. 1B. In particular, as shown, a first user may input gesture X, which may be received by a corresponding instance 118a of the interface 118 and passed to an instance 120 of the input handler 120, as shown. As described above, the input handler 120a may assign a user ID to the received gesture data. Similar comments apply to receipt of a separate gesture Y from a second user, by way of a second interface 118b and a second input handler 120b, as also shown.

A data extractor 122a may be configured to sort the data based on the assigned user IDs. The gesture mapper 124a may determine whether a given user is authorized to execute the received gesture. If not, corresponding notice may be provided to the user. If so, then the gestures X, Y may be passed to the command instructor 126a, which may determine whether the each user is permitted to perform the related command. If so, then the command instructor 126a may provide commands A (for gesture X) and B (for gesture Y) to the application 410.

In FIG. 10, in contrast, the different gestures X, Y from respective first and second user may be implemented in conjunction with the same application semantics. That is, as shown, both of gesture X from user 1 and gesture Y from user 2 may result in a command from the command instructor 126a to the application 108 to execute command A.

Thus, as referenced above, FIGS. 9 and 10 illustrate examples which illustrate the highly-flexible nature of the systems 100a, 100b of FIGS. 1A, 1B. In particular, implicit in the above description of FIGS. 9 and 10 is that security may be provided in terms of insuring that only authorized users are performing authorized uses of the framework 102 with respect to the application 410 in question, as may be checked by either or both of the gesture mapper 124a and/or the command instructor 126a.

Many other implementations are possible. For example, the system 100 of FIGS. 1A, 1B may be utilized to implement remote meetings or other collaborations. In such contexts, the system 100 may implement multi-user and/or multi-input device interactions, results of which are provided to all users, e.g., by way of access to the public internet. Compared to conventional web conferencing solutions, the system 100 may provide relatively fast executions of such screen sharing techniques, since e.g., the system 100 need only transmit raw data as determined from the at least one human input device 104.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer system including instructions recorded on a computer-readable storage medium and readable by at least one processor, the system comprising:
an input handler configured to cause the at least one processor to receive first human input events from at least one human input device and from at least one user, associate the first human input events with a first identifier, receive second human input events from the at least one human input device from the at least one user, and associate the second human input events with a second identifier; and
a command instructor configured to cause the at least one processor to relate the first human input events and the second human input events to commands of at least one application, and instruct the at least one application to execute the commands including correlating each executed command with the first identifier or the second identifier

2. The system of claim 1, wherein the first human input events are received from a first user, and the second human input events are received from a second user.

3. The system of claim 1, wherein both the first human input events and the second human input events are received from a user.

4. The system of claim 1, wherein the at least one human input device includes at least two human input devices.

5. The system of claim 1, wherein the at least one human input device includes a single human input device.

6. The system of claim 1, wherein the at least one device includes a multi-touch surface.

7. The system of claim 1, wherein the input handler is configured to receive the human input events encapsulated within data packets, and wherein the system further comprises a data extractor configured to extract raw data characterizing the first and second human input events.

8. The system of claim 1, wherein the at least one human input device is configured to transmit raw data wirelessly, and further wherein the input handler is configured to receive the first and second human input events using a wireless dongle.

9. The system of claim 1, wherein the at least one application includes at least two applications.

10. The system of claim 1, comprising a configuration manager configured to cause the at least one processor to store user-configurable configuration data characterizing a manner in which the command instructor is instructed to receive the first and second human input events and instruct execution of the commands based thereon.

11. The system of claim 1, wherein the command instructor is further configured to instruct the at least one application, by way of an application program interface thereof, to execute the commands including providing a visual display which visually correlates each executed command with the first identifier or the second identifier.

12. The system of claim 1, further comprising a gesture mapper configured to map the first human input events and/or the second human input events to corresponding gestures, wherein the command instructor is configured to relate the gestures to the commands of the at least one application.

13. A computer-implemented method for causing at least one processor to execute instructions recorded on a computer-readable storage medium, the method comprising:
receiving first human input events from at least one human input device and from at least one user;
associating the first human input events with a first identifier;
receiving second human input events from the at least one human input device from the at least one user;
associating the second human input events with a second identifier;
relating the first human input events and the second human input events to commands of at least one application; and
instructing the at least one application to execute the commands including correlating each executed command with the first identifier or the second identifier.

14. The method of claim 13, wherein the first human input events are received from a first user, and the second human input events are received from a second user.

15. The method of claim 13, wherein the at least one human input device includes at least two human input devices.

16. A computer program product, the computer program product being tangibly embodied on a computer-readable medium and comprising instructions that, when executed, are configured to cause at least one processor to:
receive first human input events from at least one human input device and from at least one user;
associate the first human input events with a first identifier;
receive second human input events from the at least one human input device from the at least one user;
associate the second human input events with a second identifier;
relate the first human input events and the second human input events to commands of at least one application; and
instruct the at least one application to execute the commands including correlating each executed command with the first identifier or the second identifier.

17. The computer program product of claim 16, wherein the receiving of the first human input events includes receiving the first human input events encapsulated within data packets, and extracting raw data therefrom for relation to the first human events and to the commands.

18. The computer program product of claim 16, wherein user-configurable configuration data is stored which characterizes a manner in which the first and second human input events are received and in which execution of the commands based thereon is instructed.

19. The computer program product of claim 16, wherein the at least one application, by way of an application program interface thereof, is instructed to execute the commands including providing a visual display which visually correlates each executed command with the first identifier or the second identifier.

20. The computer program product of claim 16, wherein the first human input events and/or the second human input events are mapped to corresponding gestures, and the gestures are related to the commands of the at least one application.
